(19) United States
(12) Patent Application Publication
(10) Pub. No.: US 2012/0185067 A1
(43) Pub. Date: Jul. 19, 2012

(54) SYSTEM AND METHOD FOR ORGANIZING ONE OR MORE BILLIARDS COMPETITIONS

(76) Inventor: Cameron Edward Cyr, Whitby (CA)

(21) Appl. No.: 13/434,667

(22) Filed: Mar. 29, 2012

Related U.S. Application Data
(63) Continuation of application No. 12/426,961, filed on Apr. 21, 2009.
(60) Provisional application No. 61/046,793, filed on Apr. 21, 2008.

(51) Int. Cl. G06F 19/00

(52) U.S. Cl. 700/92

(57) ABSTRACT

A system and method of organizing a plurality of participants in one or more billiards competitions. Specifically, the system and method schedules, tracks and scores a plurality of participants in one or more billiards competitions. The system utilizes client server technology over a network such as the Internet, with a relational database and a database management system. The method utilizes a scheduling system for scheduling participants in billiards competitions, a handicap system for allowing participants of a wide range of skill levels to competitively participate with each other and a point system for measuring participant performance in billiards competitions. The method for utilizing the scheduling system, the handicap system and the point system is integrated into the overall system.

This application claims the benefit of the filing of U.S. Provisional Patent Application 61/046,793 filed Apr. 21, 2008, the entire disclosure of which is incorporated by reference. The present application is a continuation of U. S. Non-Provisional patent application Ser. No. 12/426,961 filed on Apr. 21, 2009 the entire disclosure of which is incorporated by reference.

### TECHNICAL FIELD

### Background

The present invention generally relates to a system and method of organizing a plurality of participants in one or more billiards competitions. More specifically, the invention is a system and method for organizing a plurality of participants in one or more 9-ball billiards competitions.

It is an object of the invention to make it possible for an unlimited number of participants in one or more billiards competitions to compete anywhere in the world.

It is also an object of the invention for a plurality of participants in one or more billiards competitions to compete against each other in real-time within the same schedule without having to travel great distances or having the burden of large expenses for travelling, accommodations and other expenses.

It is also an object of the invention to allow a plurality of participants in one or more billiards competitions of different skill levels to competitively participate amongst each other and help reduce the possibility of sandbagging or cheating.

It is also an object of the invention to allow a plurality of participants to have a greater choice of who, where and when to participate in a billiards competition.

What participants and organizers of billiards competitions really need is a system and method to better schedule, track and score a plurality of participants in one or more billiards competitions.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a system's architecture of a system to organize one or more billiards competitions, in accordance with one embodiment of the present invention.

FIG. 2 illustrates a flowchart of a method for organizing one or more billiards competitions, in accordance with one embodiment of the present invention.

FIG. 3 illustrates general information about a scheduling system, in accordance with one embodiment of the present invention.

FIG. 4A illustrates a table and outline of a handicap system, in accordance with one embodiment of the present invention.

FIG. 4B illustrates a table of a minimum average of a plurality of each opponent's handicap levels, in accordance with one embodiment of the present invention.

FIGS. 5A-E illustrates a table of multiplying a plurality of factor numbers and scores, in accordance with one embodiment of the present invention.

FIGS. 6A-Q illustrates a table of a point system table with a plurality of multiplying factor numbers, in accordance with one embodiment of the present invention.

FIG. 7A illustrates a table to select a minimum point value and a maximum point value to win a match and lose a match, in accordance with one embodiment of the present invention.

FIG. 7B illustrates a table to use a 5 decimal format to find a closest 3 decimal numbers to use, in accordance with one embodiment of the present invention.

FIG. 7C illustrates a table to find a plurality of equally incremented point values using a five decimal format without going over a maximum point value or under a minimum point value that is used, in accordance with one embodiment of the present invention.

FIG. 7D illustrates a table to round a plurality of 5 decimal point values to a closest 3 decimal point values, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

The present invention generally relates to a system and method of organizing participants in billiards competitions 10. Billiards competitions are competitions any of several games played on a rectangular cloth-covered table (with cushioned edges) in which long tapering cue sticks are used to propel ivory or composition balls. These billiards competitions can also include 8-ball, 9-ball, snooker and bumper pool competitions. More specifically, the invention is a system and method for organizing participants in 9-ball billiards competitions, although other embodiments can also include 8-ball, snooker and bumper pool competitions.

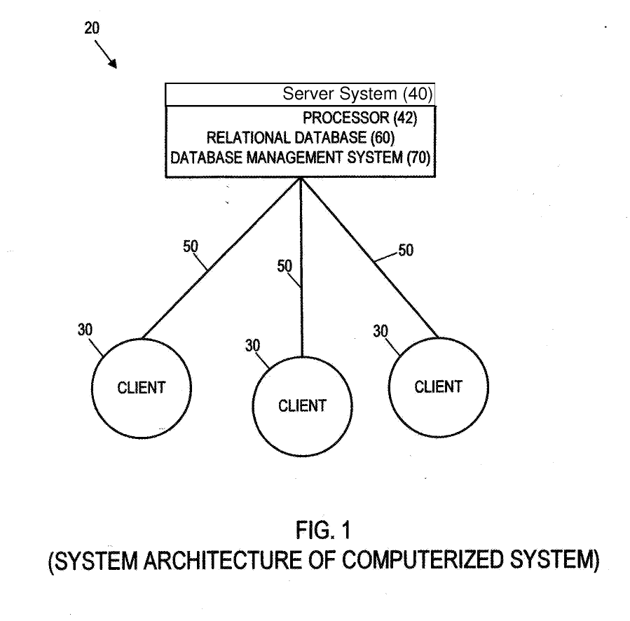

FIG. 1 illustrates a system's architecture of a system 20 to organize one or more billiards competitions, in accordance with one embodiment of the present invention. The system 20 is comprised of a client system 30, a server system 40 with a processor 42 and a communications network 50 utilized by the client system 30 and the server system 40 to communicate and exchange electronic based information. The server system 40 also has a relational database 60 to store the electronic based information with a database management system 70 to manage the relational database 60. The client system 30 is typically a personal computer and the communications network 50 used is typically the Internet, although both are not limited to a personal computer and the Internet. The system 20 utilizes typical client-server technology or other suitable technology.

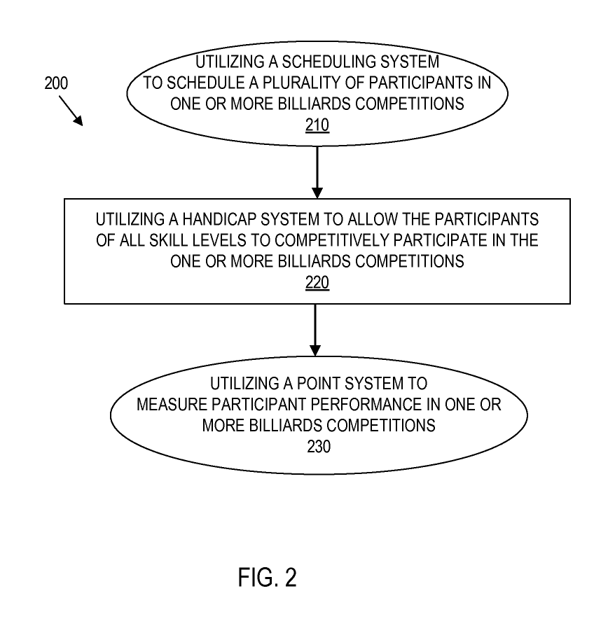

FIG. 2 illustrates a flowchart of a method 200 for organizing one or more billiards competitions, in accordance with one embodiment of the present invention. These include utilizing a scheduling system to schedule a plurality of participants in one or more billiards competitions 210, utilizing a handicap system to allow the participants of all skill levels to competitively participate in the one or more billiards competitions 220 and utilizing a point system to measure participant performance in one or more billiards competitions 230.

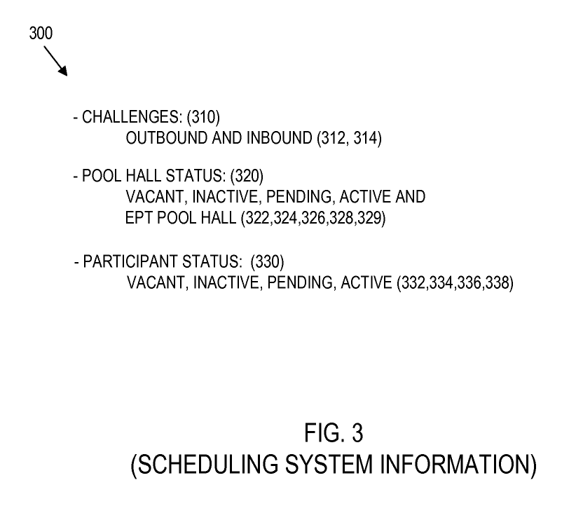

FIG. 3 lists general information about a scheduling system 300, in accordance with one embodiment of the present invention.

The scheduling system 300 includes two types of challenges 310, an outbound challenge 312 in which the participant sends a challenge with the date, time of day and pool hall venue and an inbound challenge 314 in which the participant is the recipient of a challenge. It's up to the recipient of a challenge to accept the challenge or decline the challenge. Participants have three days to accept a challenge or the challenge is automatically declined. Participants may have up to 3 outbound challenges at a time and a cumulative total of 12 challenges. A participant may not have more challenges than the number of matches left to be played with twelve matches played per session. When a challenge is accepted a match is created. Participants have two days after the match is played to enter the scores. If the match is not entered after two days the match becomes a contested match. A match also becomes a contested match if the scores do not match. Participants have a score sheet which they print out for the match. Each participant records and signs their match score sheet. One copy goes to each participant and the third copy is left with the pool hall. Either participant may have the pool hall administrator adjust the scores according to the score sheets.

Each pool hall will be assigned one of five possible statuses 320. The first status is a vacant pool hall 322, which is a pool hall with no participants that have the vacant pool hall 322 selected as their home hall. Vacant pool halls 322 are available to be selected as home pool halls but serve no other purpose. The second status is an inactive pool hall 324, which is a pool hall with no active or pending participants that have selected the pool hall as their home hall. Inactive pool halls 324 may contain participants but those participants have not joined the current session. The third status is a pending pool hall 326, which is a pool hall with less than 10 active or pending participants that have selected the pending pool hall 326 as their home hall. Pending pool halls 326 may contain active participants that can make challenges but the matches may not be played at pending pool halls 326. For this reason home participants belonging to a pending pool hall 326 may not challenge other home participants belonging to other pending pool halls 326. The fourth status is an active pool hall 328, which is a pool hall with 10 or more active or pending participants selected as their home hall. All matches are played at an active pool hall 328. Active participants belonging to an active pool hall 328 can make challenges and resulting matches that may be played at their active home pool hall subject to other EPT constraints. Note that active pool halls 328 must have an active home pool hall administrator. The fifth status is an EPT pool hall 329, which is a pool hall with 30 or more active participants with this pool hall selected as their home hall. Active participants belonging to an EPT pool hall 329 can make challenges and resulting matches that may be played at their EPT pool hall 329 subject to other EPT constraints. Note also that EPT pool halls 329 must have an active home pool hall administrator.

Each participant will be assigned one of four possible statuses 330. The first status is a vacant participant 332, which is a participant that has registered in a previous year but is not registered in the current year. The second status is an inactive participant 334, which is a participant that is registered in the current year but has not enrolled in the current session. The third status is a pending participant 336, which is a participant that has enrolled in the current session, but does not have an EPT pool hall 329 on their preferred pool hall list. The fourth status is an active participant 338 that is enrolled in the current session and has an EPT pool hall 329 on their preferred pool hall list.

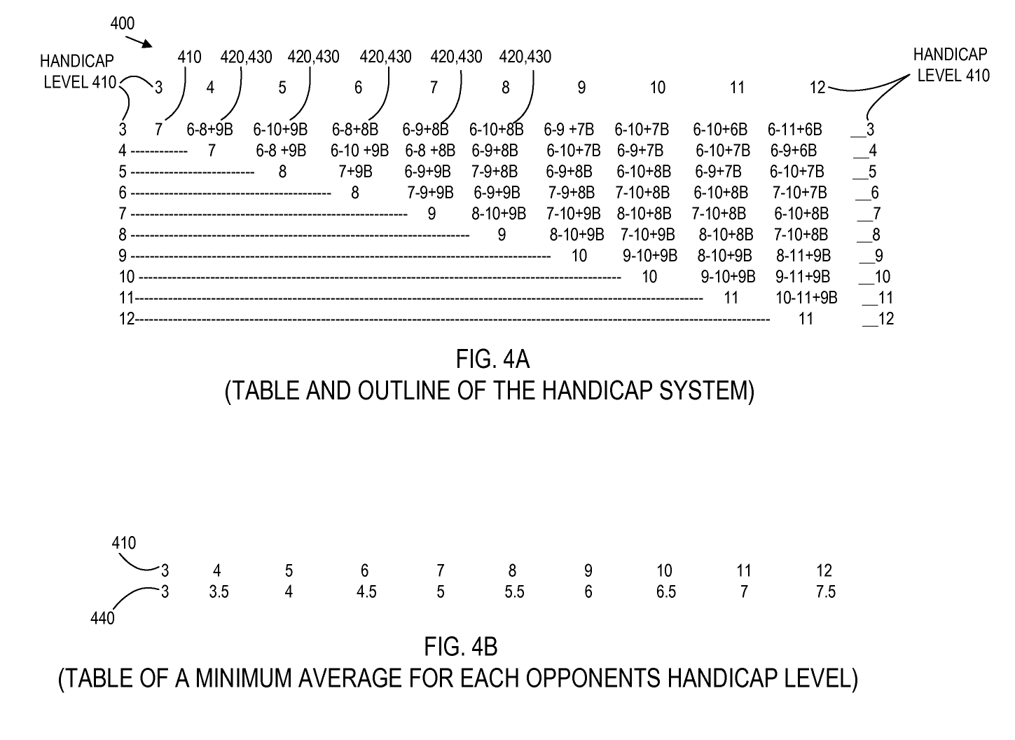

FIG. 4A illustrates a table and outline of a handicap system 400, in accordance with one embodiment of the present invention.

The number of games each handicap level 410 needs to win in order to win a match is indicated by the single numbers 7, 8, 9, 10 or 11 or by two hyphened numbers on the table 420. The smaller number refers to the lower ranked participant. The +98, +88, +78 and +68 430 indicates which extra winning balls the lower ranked participant has to sink to win the match. If it's a +68 ball, this means the winning balls are the 6, 7, 8 and 9 balls. If it's a +78 ball, then the winning balls are the 7, 8 and 9 and for a+88 ball, then the winning balls are the 8 and 9. In looking at FIG. 4A, when a handicap level 3 (821) plays another handicap level 3 (A23), they both are racing to be the first to win 7 games. The first participant to win 7 games wins the match. When a handicap level 4 (C21) plays a handicap level 3 (A23), the handicap level 3 needs to win 6 games to win the match and the handicap level 4 needs to win 8 games to win the match as indicated by the 6-8+98. The +98 means both participants only have the nine ball for their winning balls. When a handicap level 6 (E21) plays a handicap level 3 (A23), the handicap level 3 needs to win 6 games to win the match and the handicap level 6 needs to win 8 games to win the match as indicated by the 6-8+88. The +88 means the lower ranked participant, handicap level 3 has the 8 ball and the nine ball for his or her winning ball. The handicap level 6 only has the nine ball for his or her winning ball. Extra winning balls are only given to the lower ranked participants of a match when indicated.

FIG. 4B illustrates a table of a minimum average of a plurality of each opponent's handicap levels 440, in accordance with one embodiment of the present invention. FIG. 4B illustrates a table of a minimum average for each opponent's handicap levels 410 at the end of 12 weeks (9 out of 12 matches). Participants must play a minimum average for each of their opponent's handicap levels 410. For example, 12's must play an average of a 7.5 handicap, meaning they could play six 7's and six 8's which average out to 7.5. However the 12's could not play seven 7's and five 8's because this only totals 7.42.

Without the scores 620 and multiplying factor numbers 610 there would be too many ties and would be too difficult to determine winners. By determining the winners by a weekly score, any playoffs are eliminated. With this format in place, the billiards competition can have an unlimited number of participants playing anywhere, any time in the world. There are four 12 week sessions played per year. The first three sessions are played in, for participants to win money plus to qualify for the “Big Money 4th session”. Half the money of the four regular sessions goes into the “Big Money 4th session”. In the fourth session about half the participants will have qualified to play for the “Big Money 4^{th} session” and the other half will play for the “Regular Money 4th session”. At the end of every 12 week session, the winners are determined by their total weekly points. By using the participant's weekly points, this eliminates having to get all the participants together to play to determine the winners. Also the factor numbers are used to allow the point system to eliminate too many ties, to help prevent participants from cheating the system and to encourage participants to play their best at all times. The scheduling system allows participants to match themselves up to an opponent closest to their preference of skill level. It also allows the participants more variety and choice of when and where to play their matches.

In the fourth session, qualifying participants play for the “Big Money 4th session” while the other participants play for the “Regular Money 4th session”. All of the participants play amongst each other just like any other 12 week session. The only difference is approximately half will be playing for the “Big Money 4th session” and the other half will be playing for the “Regular Money 4th session”. This also gives more participants a fair and better chance of winning prize money because the stronger participants will be playing for the “Big Money 4th session” leaving the rest of the participants to play for the “Regular Money 41th session” of which there are only half as many participants as usual.

In each match a participant will earn anywhere from a minimum of 75 points to a maximum of 150 points. For example, if one participant won all the games and the score was 8-0 then the winning participant would get 150 points and the losing participant would get 75 points. By just showing up a participant will earn no less than 75 points. Depending on what the two participants' handicap levels are, they will each have a number of games to win or race to in order to win the match. The winner will receive a certain number of points somewhere from 120 to 150 depending on how many games they lost. The losing participant will receive a certain number of points somewhere from 75 to 115 depending on how many games they won. Anywhere from 6 to 11 games will need to be won by either participant depending on what caliber of participant or handicap level they are. This is the range of games needed to be won to win a match. There is also more than one winning ball given to some participants depending on the handicap spread.

This is explained in FIG. 4A and its description. Each participant is given a range of points they can earn and not win because even a losing participant with no wins will receive points. Depending on both participant's handicap levels and the spread or difference of the two participants, FIG. 4A will determine how many games each participant needs to win in order to win the match. Also, for each handicap point spread of both participants, the maximum and minimum points available will be lowered and raised by 2 points. That is the maximum points of 150 points will be lowered by 2 points for every handicap level difference of the two participants and the minimum points of 75 points will be raised by 2 points for every handicap level difference of the two participants. For example, if a 3 were playing a 4 then the maximum points would start at 148 and the minimum points would start at 77 points instead of 150 to 75. If a 3 were playing a 5 then it would be from 146 to 79. If a 3 were playing a 12 then (12−=9) is the spread, (9×2=18) is the two points per spread difference, (150−18=132) and (75+18=93) then it would be 132 to 93.

There are 5 factors to consider when calculating each participant's points for the point system. The factors are both participants' handicap level, the two participants' handicap spread difference, the total games each participant needs to win to win the match and the participant's best midrange scores then expanding outward alternating back and forth from left side to right side. Both participants' handicap level and the difference between the two participant's handicap levels will determine how many games either participant needs to win in order to win the match. For each handicap point spread of both participants, each participant will add 2 points to his or her bottom end of their points table on the losing side and subtract 2 points from his or her top end of their points table on the winning side. For example, if a 3 were playing a 4 then the two participant's points table would be from 115 to 77 on the losing side instead of 115 to 75 and 148 to 120 on the winning side instead of 150 to 120. If a 3 were playing a 5 then it would be from 115 to 79 and 146 to 120. If a 3 were playing a 12 then (12−3=9), (9×2=18), (75+18=93) and (150−18=132) then it would be 115 to 93 and 132 to 120. The number of games needed to be won for any particular match is between 6 and 11. Therefore, the point range for a participant needing to win 6 games will be determined by 2 factors. One will be the spread difference, giving the participant their minimum and maximum available points and the second will be the number of games which will determine the number of point values in an equal sequential order in between these two ranges of top and bottom point values. The factor numbers will eliminate the vast number of ties, give value to every single game of each match, eliminate participants from throwing games and cause participants to play their best at all times.

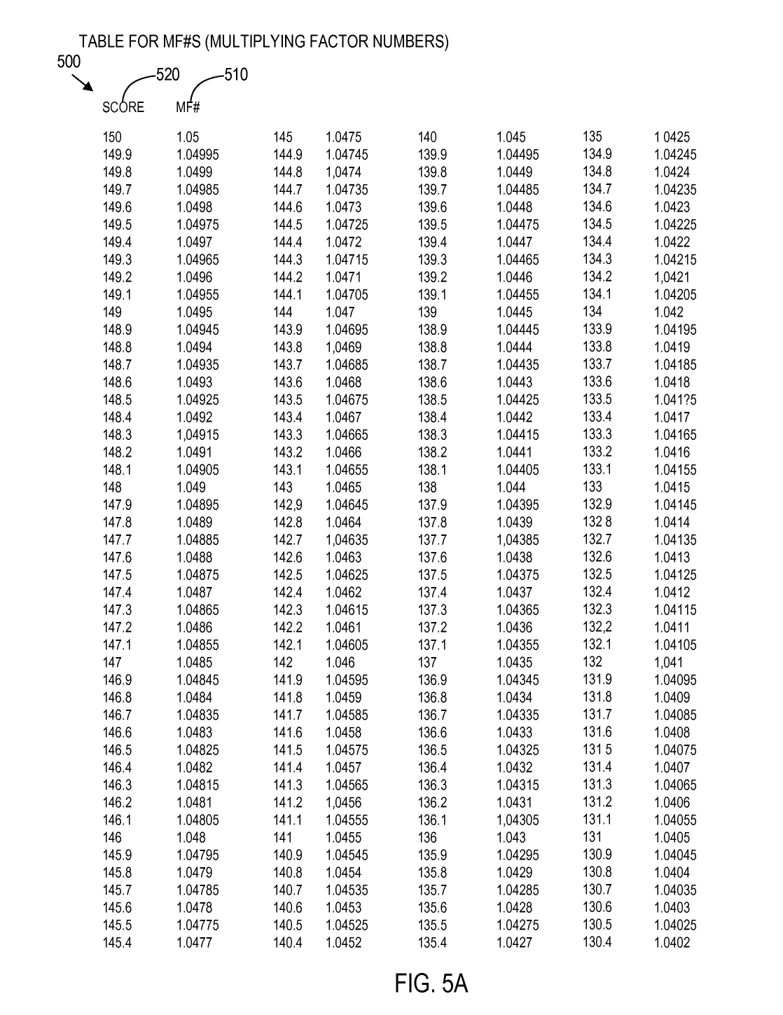

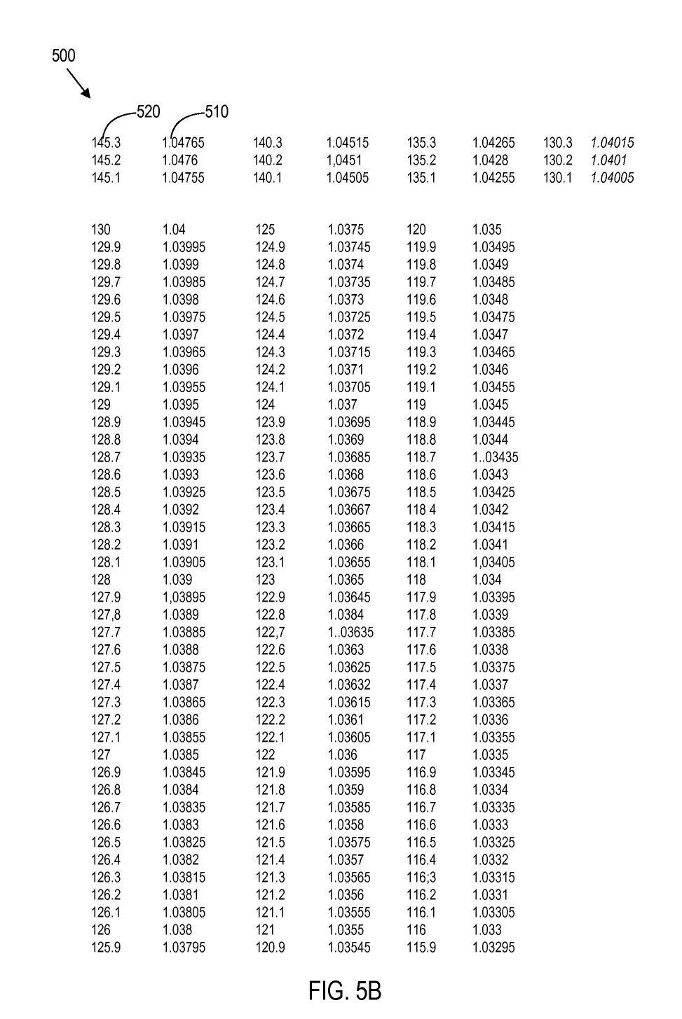

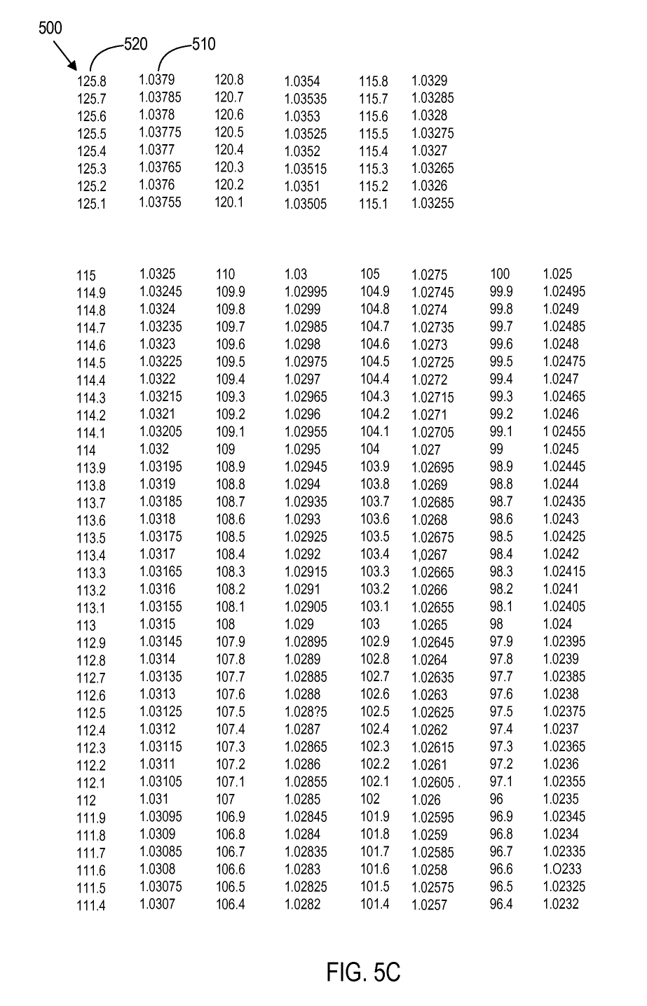

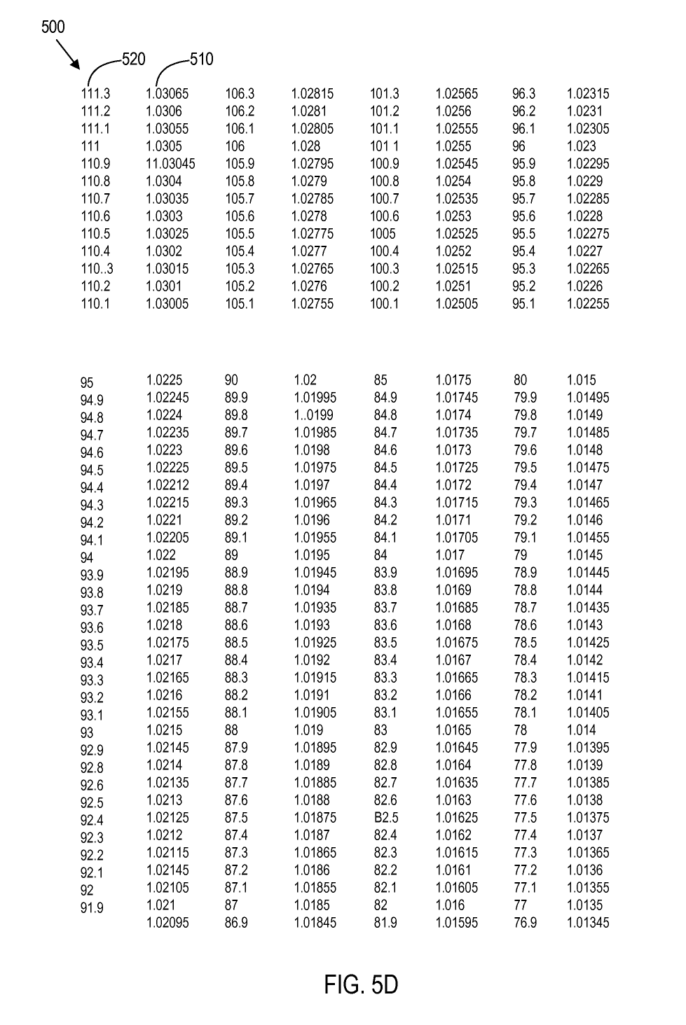

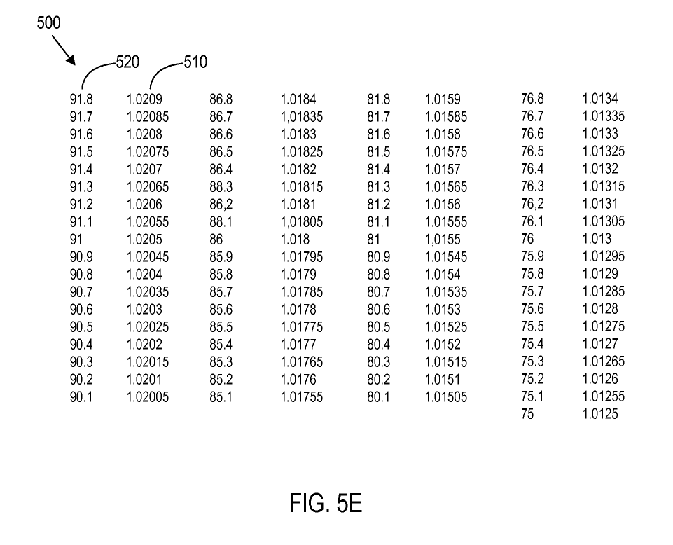

FIGS. 5A-E illustrates a table 500 of multiplying a plurality of factor numbers 510 and scores 520, in accordance with one embodiment of the present invention. Table 500 expresses the factor numbers 510 out to 4 decimal places and 5 decimal places. There are two factor numbers 510 used. The first factor number 512 is a five decimal number ranging from 1.01250 to 1.05000. The first factor number 512 is used to eliminate the possibility of many participants tying. In the four regular sessions, points from each match have this corresponding factor numbers 510 which is multiplied together to get that matches final points. The second factor numbers 514 is a four decimal number ranging from 1.1250 to 1.5000. The second factor numbers 514 is used to make every match count, to stop the sandbagging and cheating, and to give extra reason for participants to play their best at all 10 times. This second factor numbers 514 is the result of the first factor number 512, then multiplying it by 10 and subtracting 9 to generate a larger factor numbers 516 with more weight. The larger factor number 516 is used by participants who have qualified for the final “Big Money 4^{th} session” purse. The “Big Money 4th Session” doesn't use a corresponding factor number 510 through the session but uses the original point values and multiplies this number by the larger factor numbers 516 at the end of each match. When calculating the participants' best points, each participant's matches are put in order from their best to their lowest point values. Then the points of the best 6 midrange matches are totaled for each participant. The participants who have tied will then include their next top midrange match. Any participants who tie after that will then include their bottom midrange match. Any ties after that, the same format will continue from left to right until all ties are eliminated.

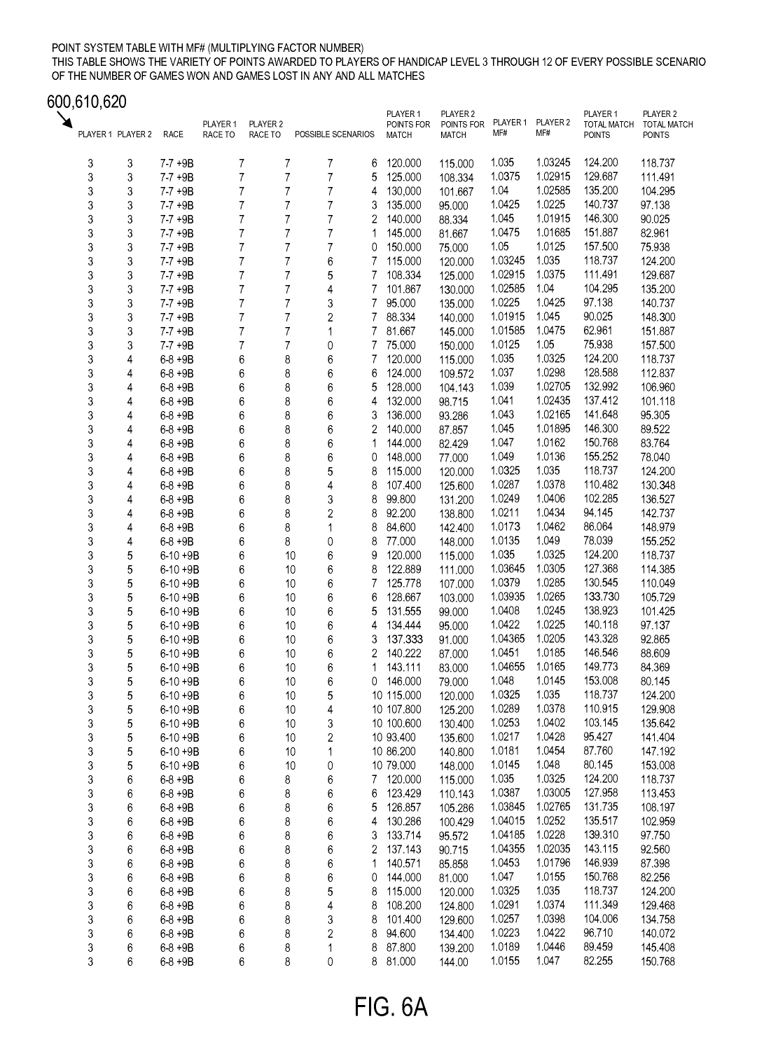

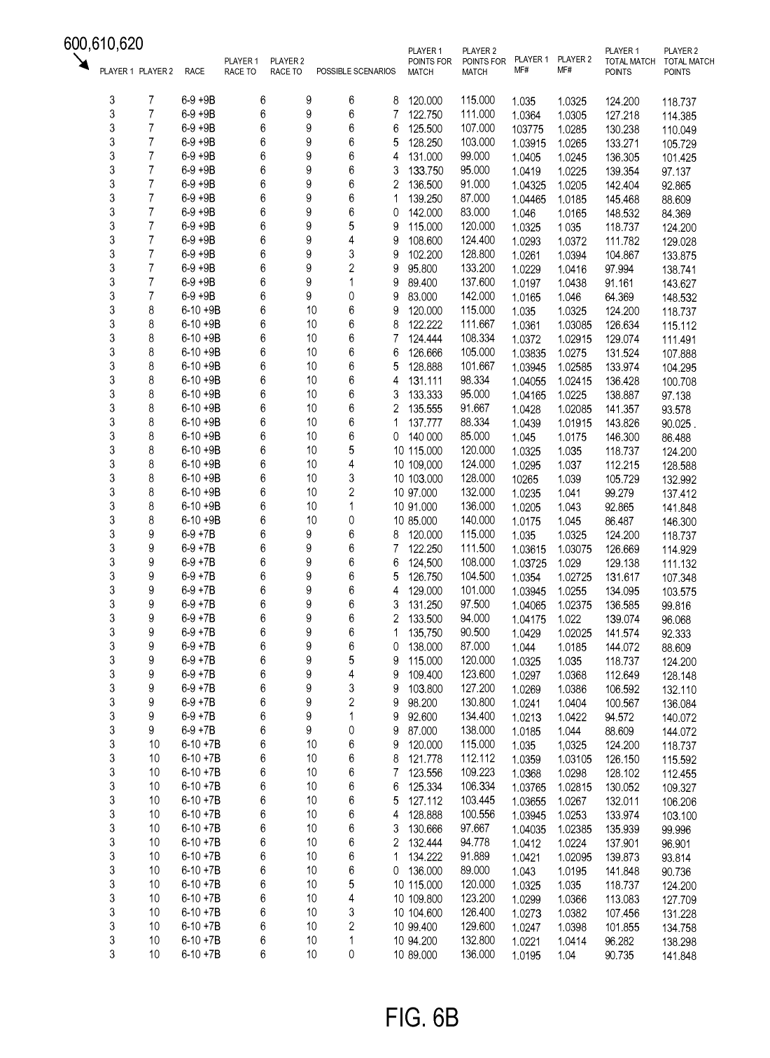

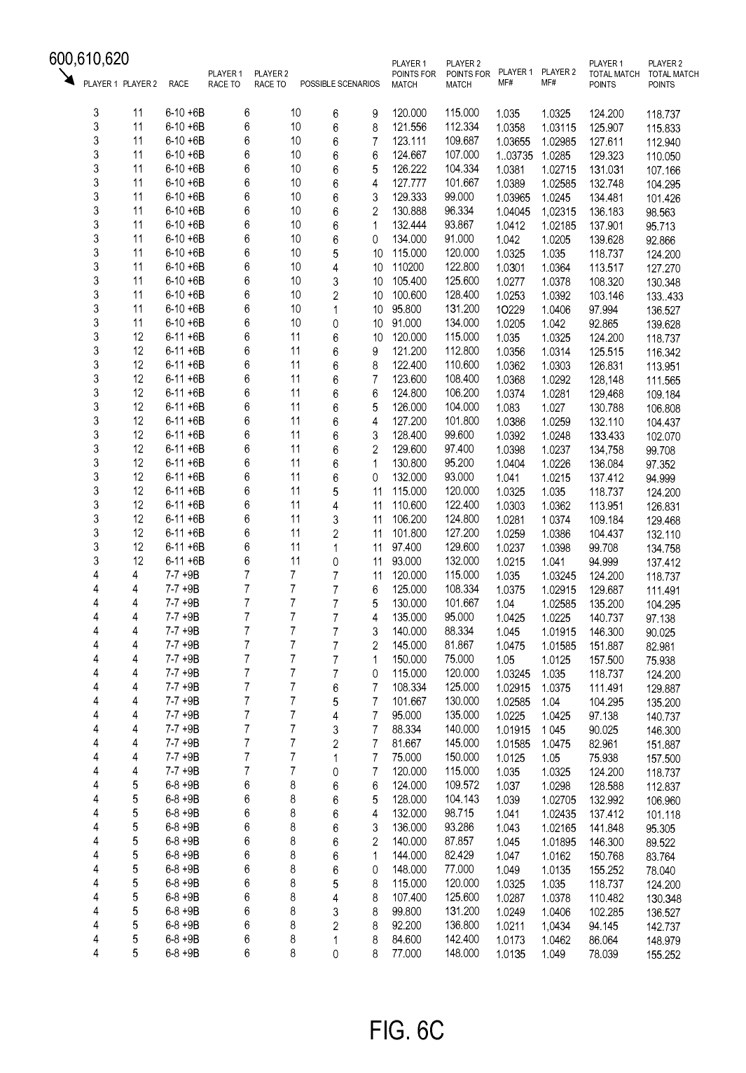

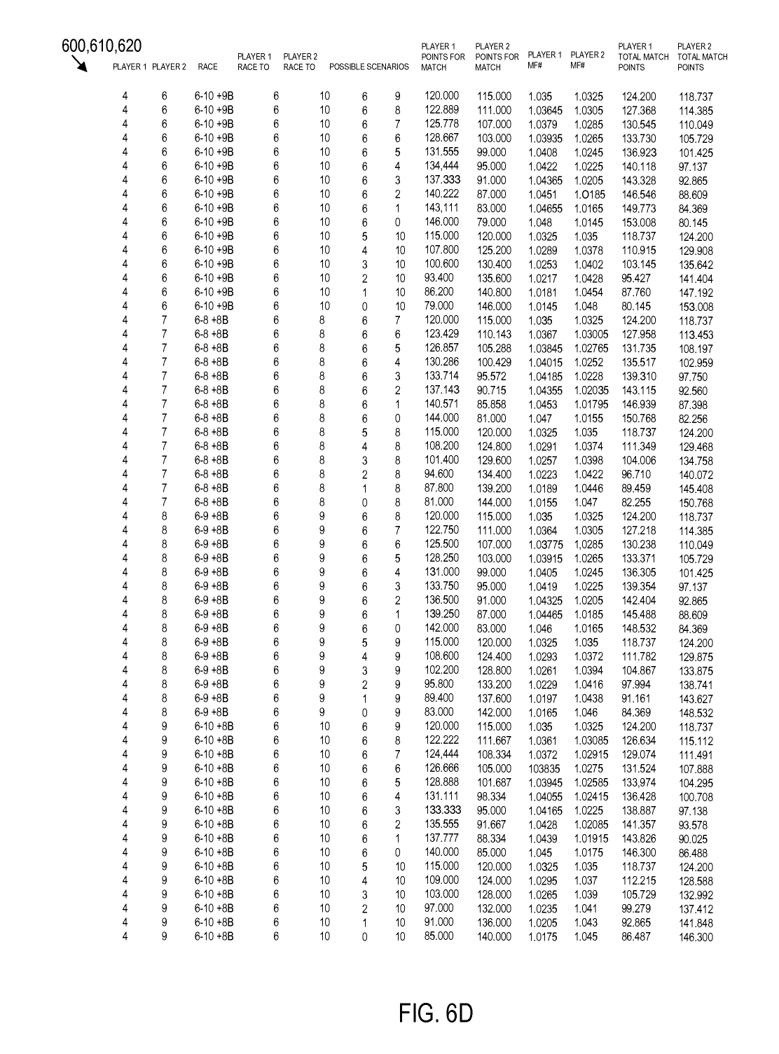

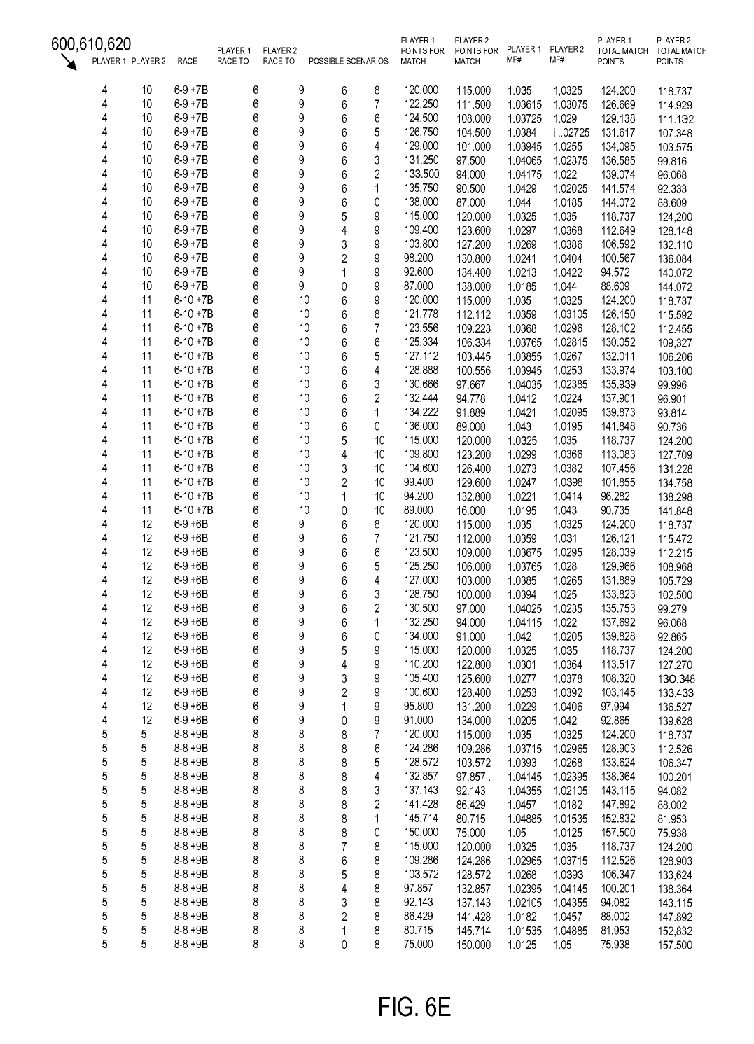

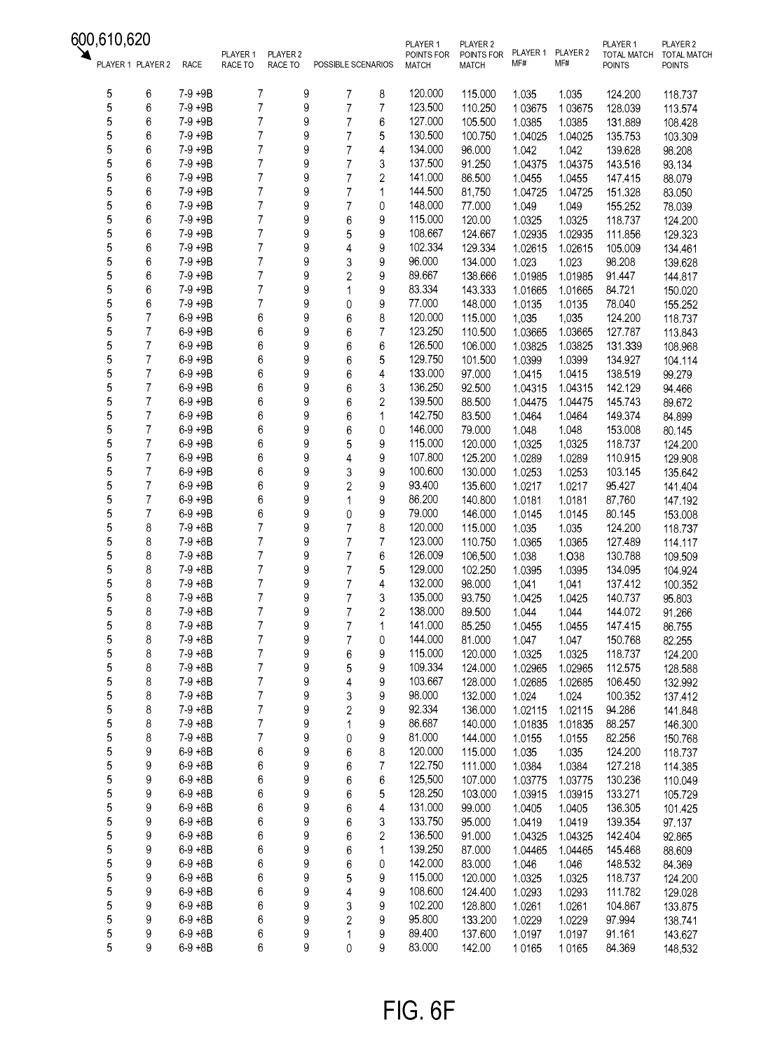

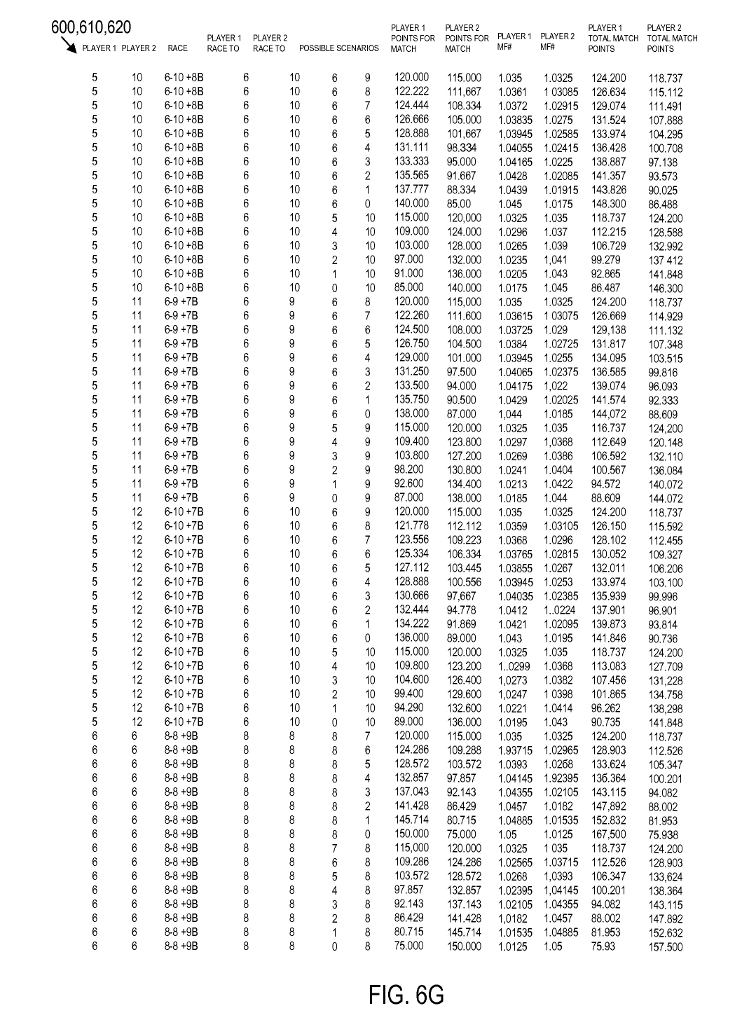

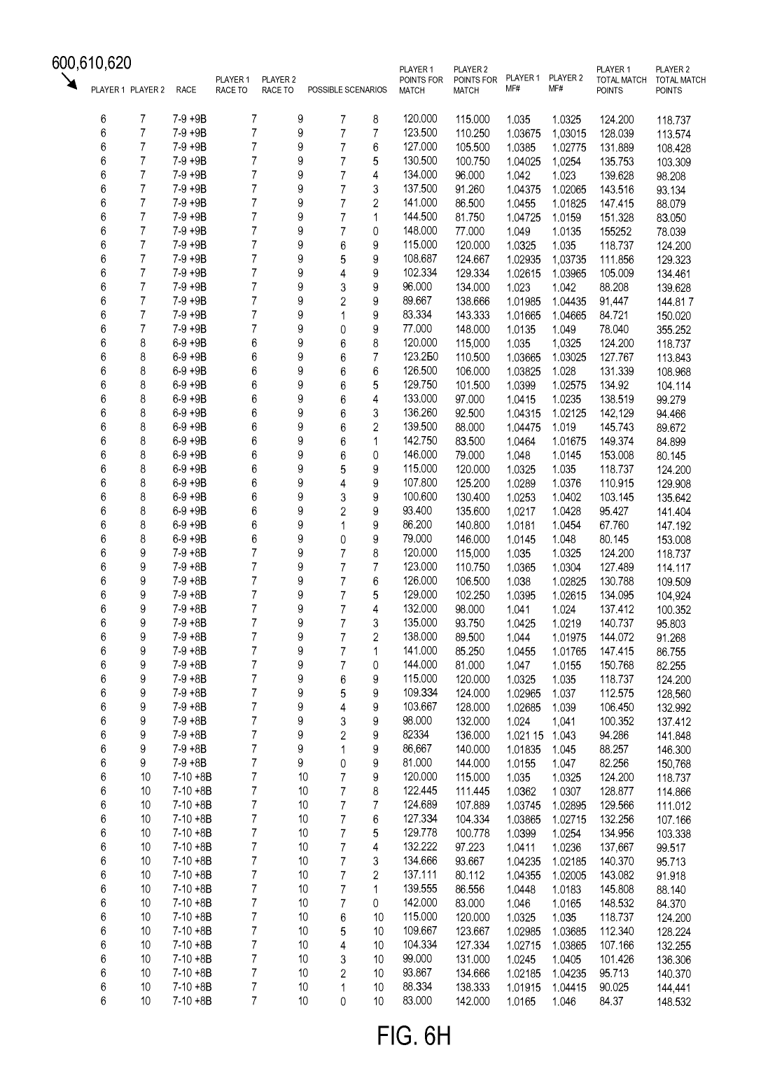

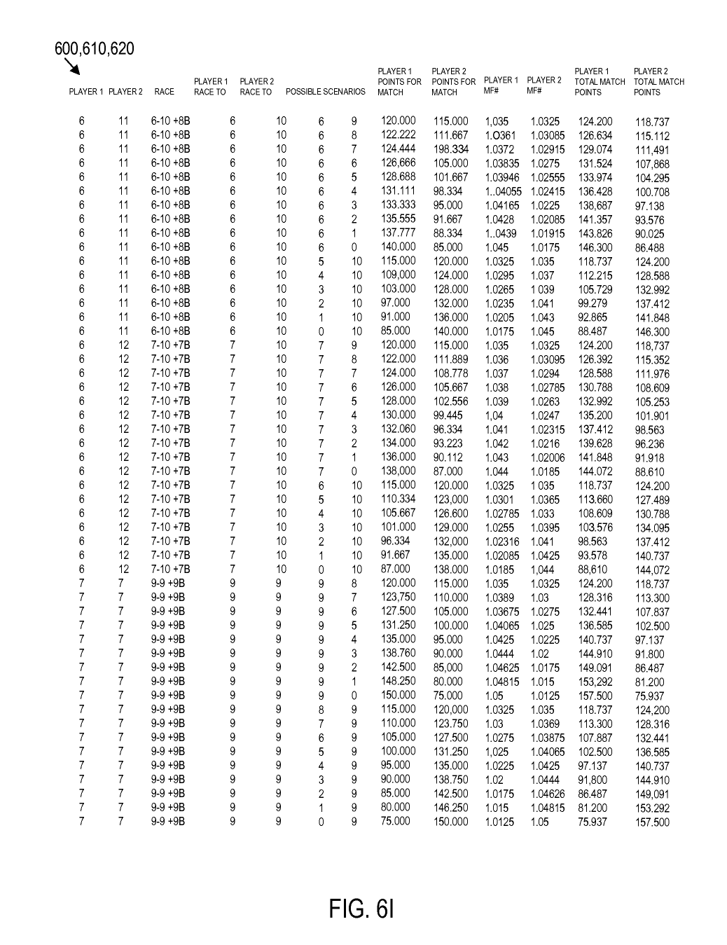

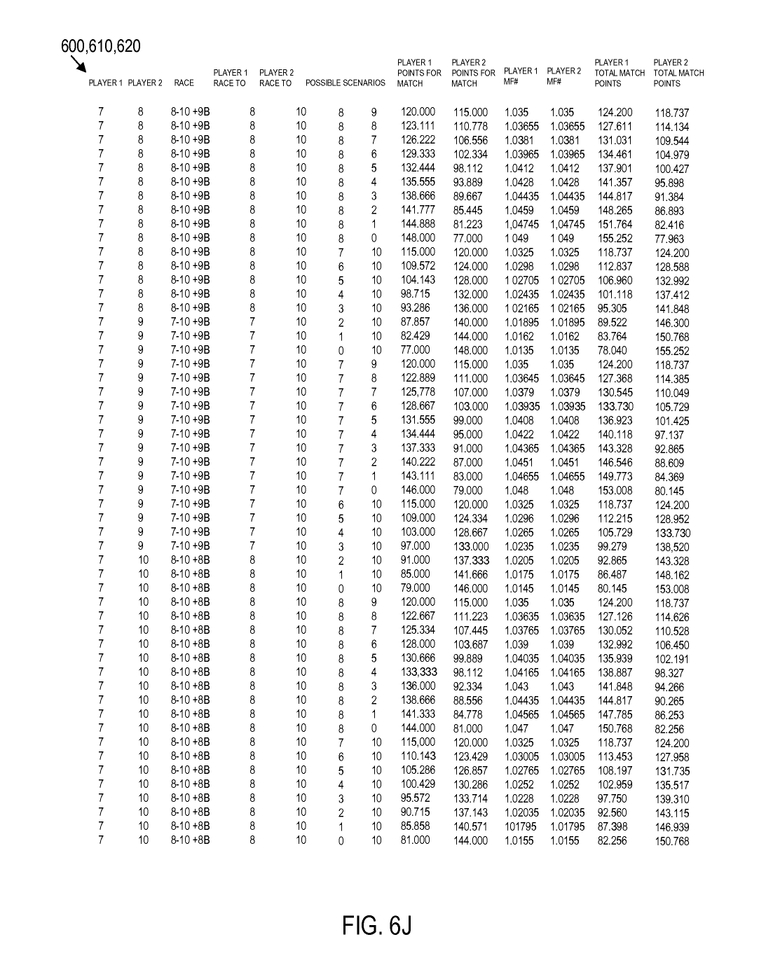

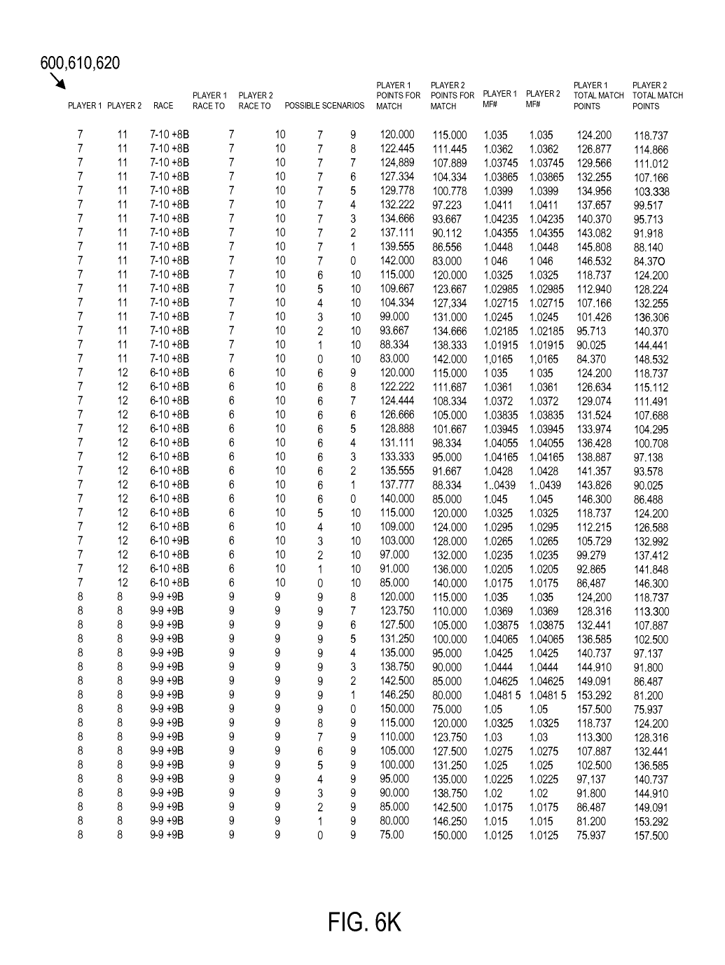

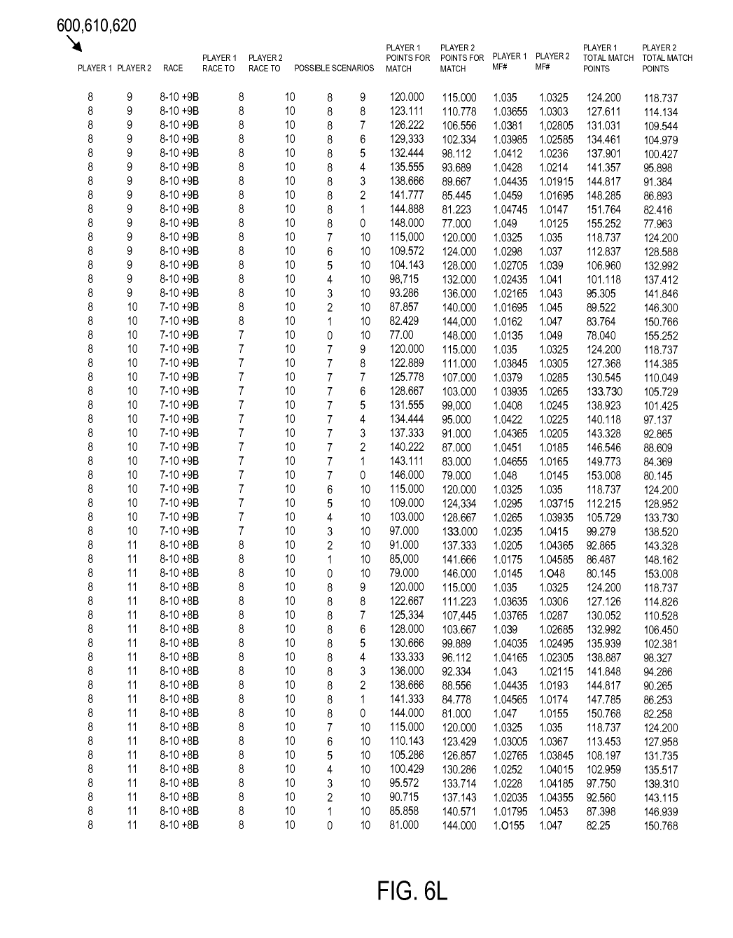

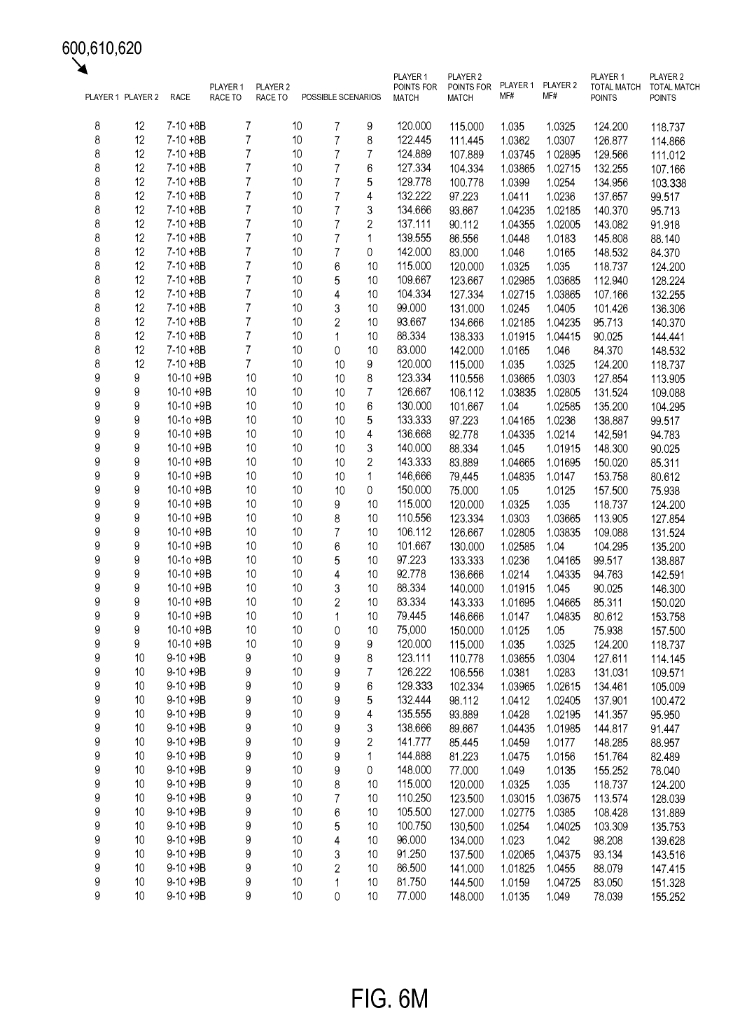

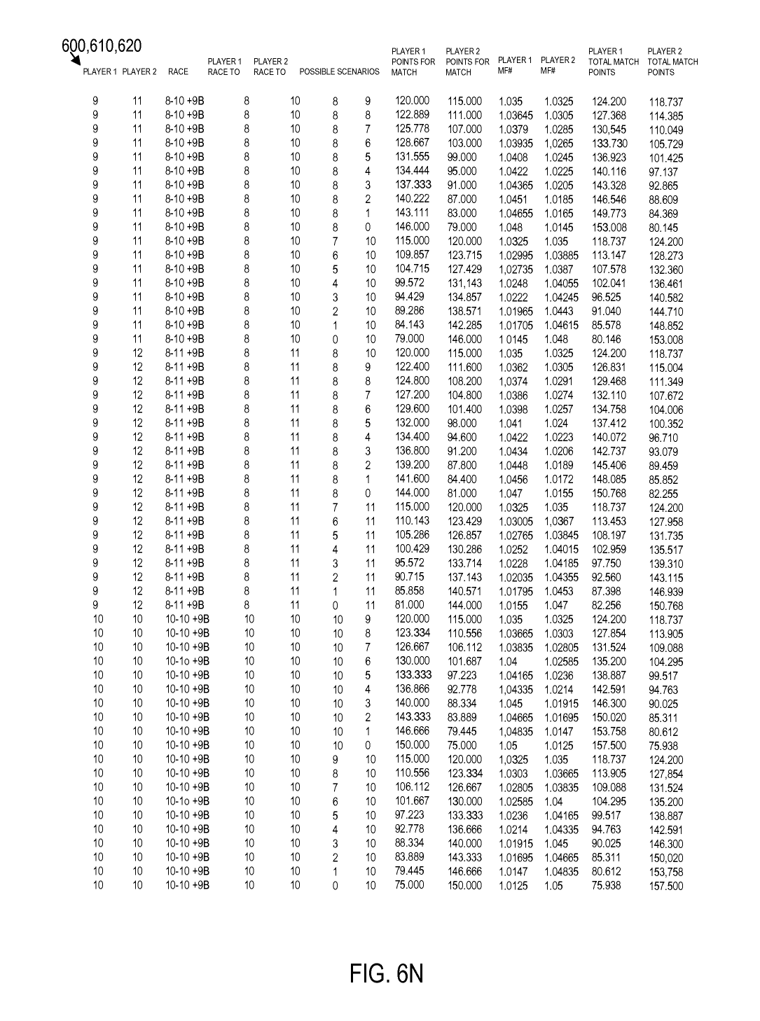

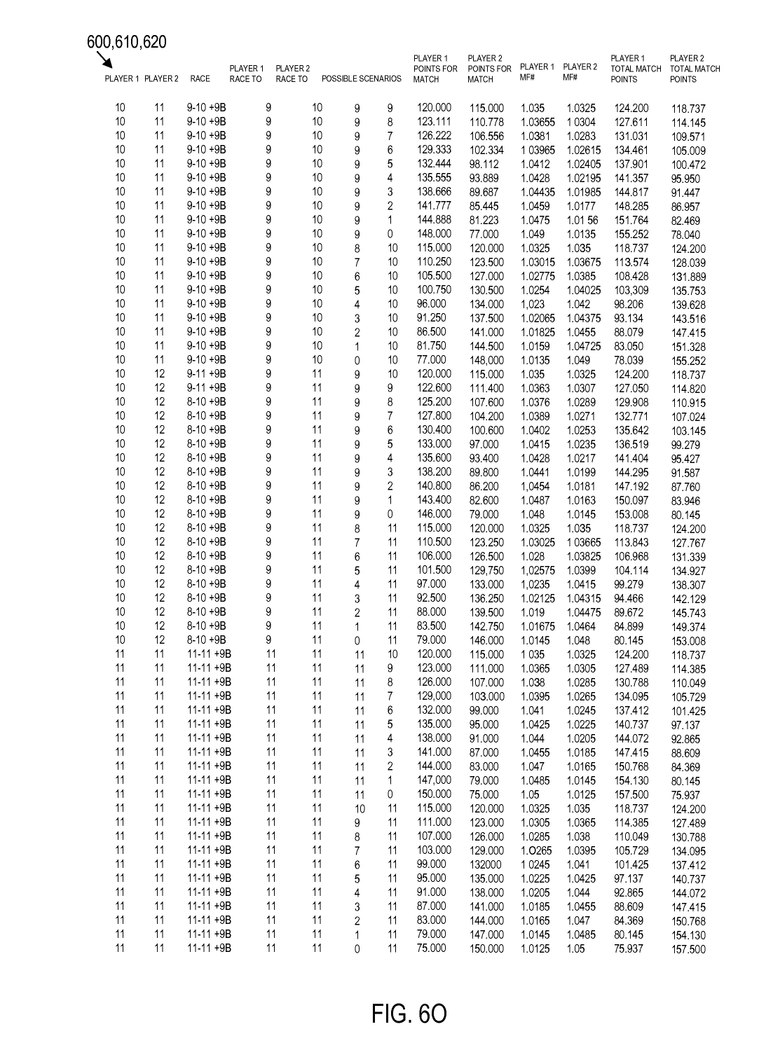

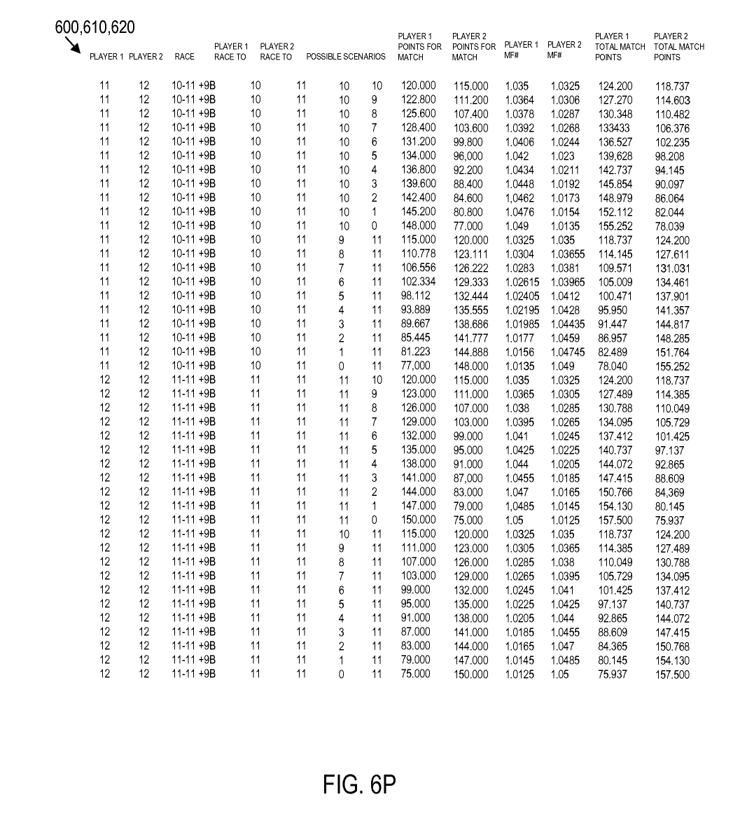

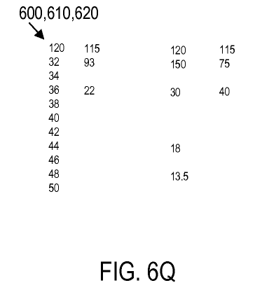

FIGS. 6A-Q illustrates a point system table 600 with a plurality of multiplying factor numbers 610 and a plurality of scores 620, in accordance with one embodiment of the present invention.

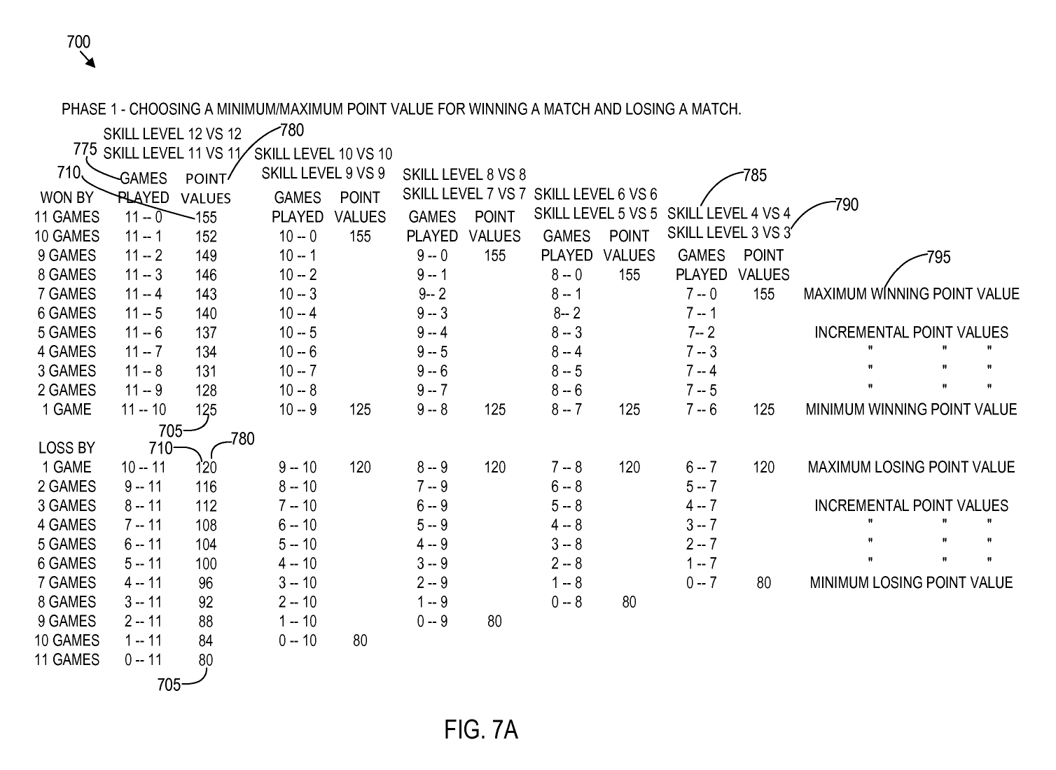

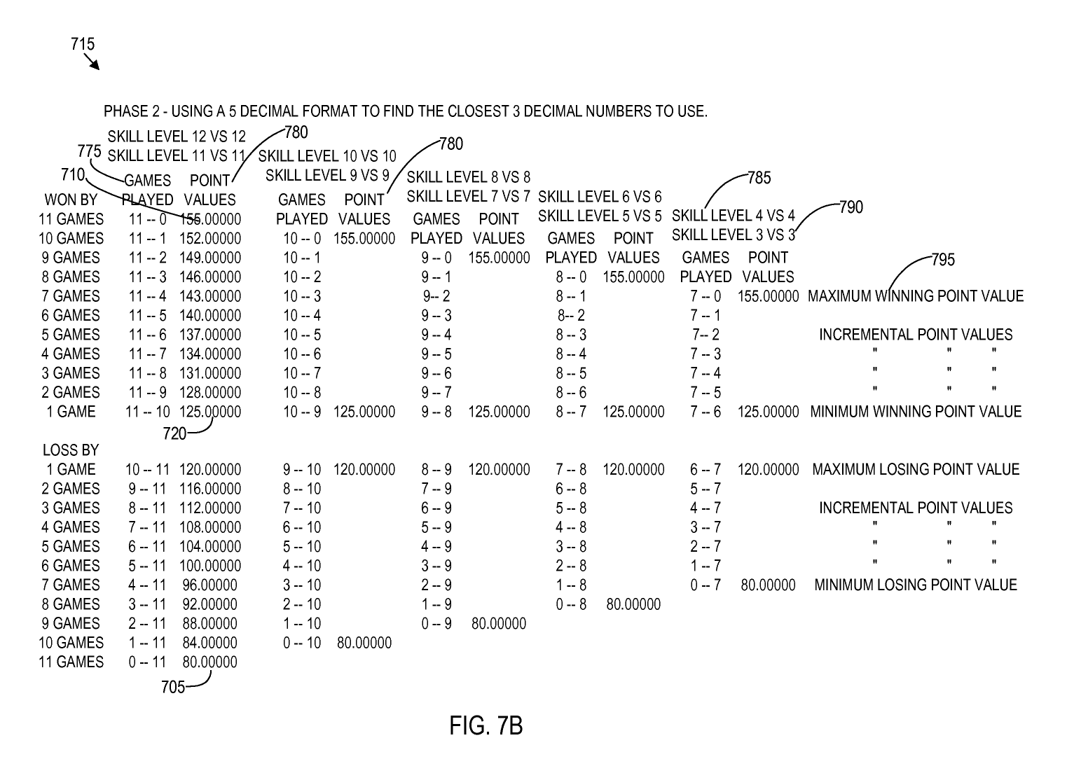

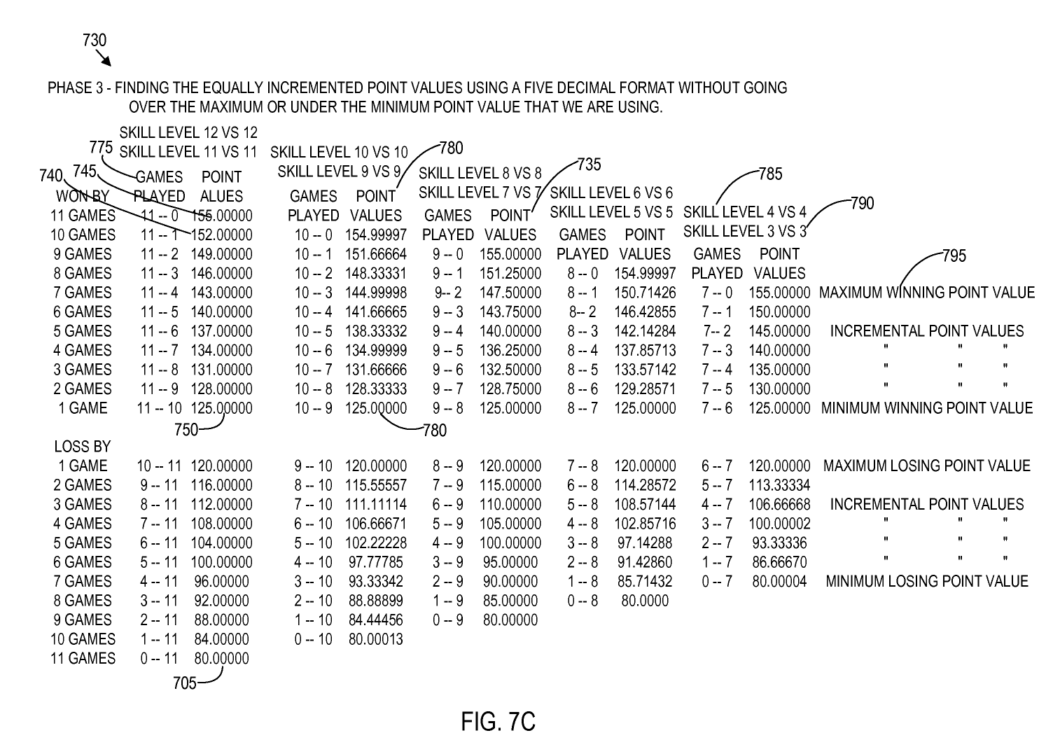

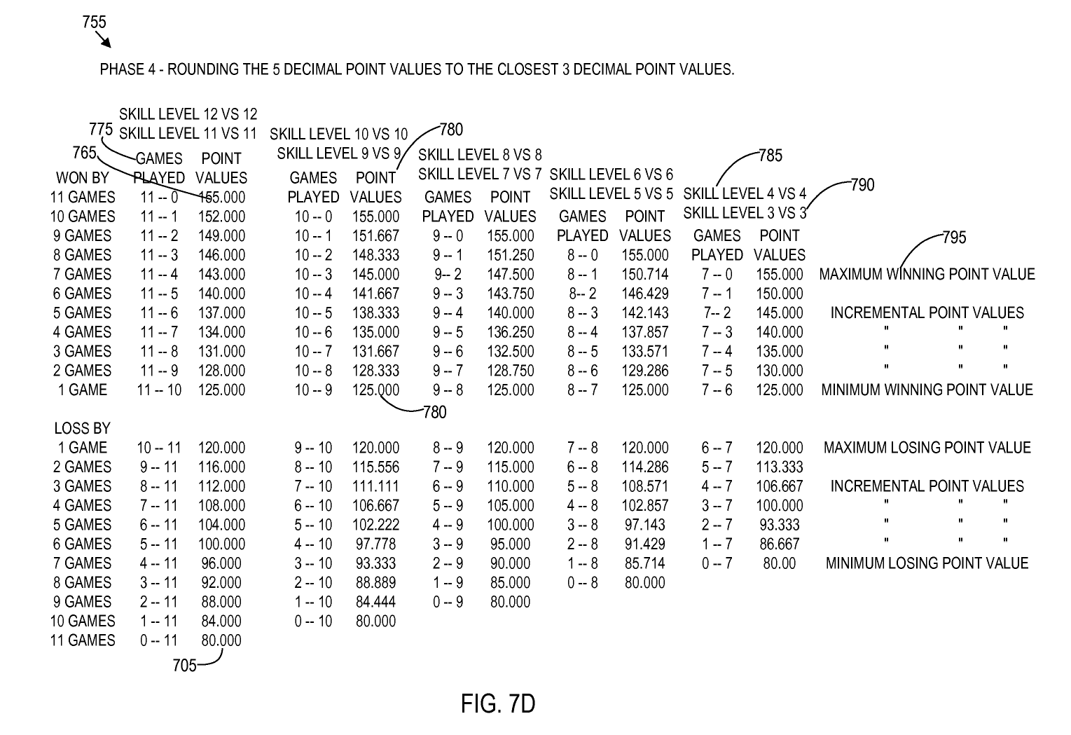

FIG. 7A illustrates a table 700 to select a minimum point value 705 and a maximum point value 710 to win a match and lose a match, in accordance with one embodiment of the present invention.

The table 700 includes a minimum point value 705 and a maximum point value 710 to win a match and lose a match, a plurality of games played 775, a plurality of point values 780, two skill levels 785,790 and a description 795 of the point values 795. The table 700 can be used to select the minimum point value 705 and the maximum point value 710 to win a match and lose a match.

FIG. 7B illustrates a table 715 to use a 5 decimal format 720 to find a closest 3 decimal numbers to use, in accordance with one embodiment of the present invention.

The table 715 includes a 5 decimal format 720, a plurality of games played 775, a plurality of point values 780, two skill levels 785,790 and a description of the point values 795.

FIG. 7C illustrates a table 730 to find a plurality of equally incremented point values 735 using a five decimal format 740 without going over a maximum point value 745 or under a minimum point value 750 that is used, in accordance with one embodiment of the present invention.

The table 730 includes a plurality of equally incremented point values 735, a five decimal format 740, a plurality of games played 775, a plurality of point values 780, two skill levels 785,790 and a description of the point values 795. The table 730 uses the equally incremented point values 735 to find the five decimal format 740 without going over a maximum point value 745 or under a minimum point value 750.

FIG. 7D illustrates a table 755 to round a plurality of 5 decimal point values to a closest 3 decimal point values 765, in accordance with one embodiment of the present invention.

The table 755 includes a plurality of closest 3 decimal point values 765, a plurality of games played 775, a plurality of point values 780, two skill levels 785,790 and a description of the point values 795.

Players can compete against an unlimited number of opponents from all over the world without actually playing them. The system is not a virtual competition that is played on a computer. Players use the computer and the Internet to simply schedule and record the matches. Each match is played physically on one or more pool tables of one or more pool halls. The reason a three decimal format is used is to get equally incremented point values because of a plurality of different point values depending on how many games in a match are to be played. Some game races are to 11, some to 10, some to 9, some to 8, some to 7, some to 6 etc. This is shown in FIGS. 7A-D. Depending on how well both players do against each other they are given a point value for each match they play. The point value is dependent on how many games the race is as well as how many games are won and how many games are lost in the match. Each point value for winning a match corresponds to a point value for losing the same match. In other words, if one player won the match by 3 games then the other player must have lost the match by 3 games, i.e., the same amount of games. The basic origin of the point system starts with a winning minimum/maximum point value and a losing minimum/maximum point value.

There are two problems. Matches do not have the same number of games raced to or the same number of games that need to be won and also each point value needs to be equally incremented between each other for each different set of number of games needed. Therefore, a decimal format is needed because some game races are to 11, some to 10, some to 9, some to 8, some to 7, some to 6 etc. The point system starts with a 5 decimal format and is rounded to a 3 decimal number to get the point values for each number of games won and lost for each match. The point system starts with the top skill level (skill level 12) that has the most games a player would have to go to find the base numbers. Players that lost the match by the maximum number of games (did not win any games) are to earn no less than half the points of the players that won the match which of course would be won by the maximum number of games. A decimal format is used to get equally incremented numbers for the point values used that are in between the maximum and minimum numbers used. The incremental point values between each point value for a win are slightly less than the incremental point values between each point value for a loss. The winning point values of a skill level 12 are incremented by a value of 4 points. This gives a chance to any players that win and lose their matches on the hill the ability to win the top amounts in a session. For example, a player won 6 matches on the hill and lost 6 matches on the hill (a match won or lost by a difference of one game). Another player won 6 matches by a difference of 2 games and lost 6 matches by a difference of 2 games. The player winning their matches on the hill would end up with a point average higher than another player who won 6 games and lost 6 games each by a difference of 2 games. The incremental point value between a hill match win and a hill match loss is 5 points. The 5 point spread works well with the other two (3 and 4) incremental point spreads as well.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A system to schedule, track and score a plurality of participants in one or more billiards competitions, comprising:
a client system;
a server system with a processor;
a communications network utilized by said client system and said server system to communicate and exchange electronic based information;
a database to store said electronic based information integrated within said server system; and
a software module to schedule, track and score said participants in said one or more billiards competitions data stored on said database, wherein said electronic based information includes said schedule, track and score said participants in said one or more billiards competitions data.

2. The system according to claim 1, wherein said network is the Internet.

3. The system according to claim 1, wherein said schedule, track and score said participants in said one or more billiards competitions data includes a scheduling system to schedule said participants in said billiards competitions, a handicap system to allow said participants of a plurality of skill levels to competitively participate in said billiards competitions and a point system to measure said participant's performance in said billiards competitions.

4. The system according to claim 3, wherein said participants have a vacant, an inactive, a pending or an active status.

5. The system according to claim 3, wherein said scheduling system allows said participants to send an outbound challenge with a date, a time of day and a pool hall venue.

6. The system according to claim 5, wherein said pool hall venue has a vacant, an inactive, a pending, an active or an EPT pool hall status.

7. The system according to claim 3, wherein said scheduling system allows said participants to receive an inbound challenge from said outbound challenge.

8. The system according to claim 3, wherein said handicap system assigns a numeric handicap level to said participants.

9. The system according to claim 3, wherein said handicap system utilizes a multiplying factor number and a score.

10. The system according to claim 3, wherein said point system utilizes said participant's points to match a multiplying factor number to determine said participants total match points.

11. The system according to claim 3, wherein said system includes a minimum point value and a maximum point value that are used to select said minimum point value and said maximum point value to win a match and to lose said match.

12. The system according to claim 3, wherein said system includes a 5 decimal format.

13. The system according to claim 12, wherein said system is used to round said 5 decimal point values from said closest 3 decimal point values.

14. The system according to claim 13, wherein said system includes a plurality of equally incremented point values and said five decimal format that uses said equally incremented point values to find said five decimal format.

15. The system according to claim 3, wherein said system includes a plurality of point values and a plurality of games played that compares said point values and said games played between two skill levels.

16. A method for scheduling, scoring and tracking a plurality of participants in one or more billiards competitions, comprising:
utilizing a scheduling system to schedule said participants in said billiards competitions,
utilizing a handicap system to allow said participants of a plurality of skill levels to competitively participate in said billiards competitions, and
utilizing a point system to measure said participants performance in said billiards competitions.

17. The method according to claim 16, wherein said method includes a 5 decimal format.

18. The method according to claim 17, wherein said method is used to round said 5 decimal point values from said closest 3 decimal point values.

19. The method according to claim 16, wherein said method includes a plurality of equally incremented point values and said five decimal format that uses said equally incremented point values to find said five decimal format.

20. The method according to claim 16, wherein said method includes a plurality of point values and a plurality of games played that compares said point values and said games played between two skill levels.
